(19) United States
(12) Patent Application Publication
(10) Pub. No.: US 2024/0203239 A1
(43) Pub. Date: Jun. 20, 2024

(54) Method for determining detecting thresholds of a constant false alarm rate device of a sensor and associated devices and method

(71) Applicant: THALES, Meudon (FR)

(72) Inventors: Adrien GILLIOT, Merignac (FR); Vincent CORRETJA, Merignac (FR)

(21) Appl. No.: 18/544,718

(22) Filed: Dec. 19, 2023

(30) Foreign Application Priority Data
Dec. 20, 2022 (FR) 22 13942

(51) Int. Cl. G08B 29/18

(52) U.S. Cl. CPC G08B 29/185

(57) ABSTRACT

The present invention relates to a method for determining detection thresholds of a CFAR detection system of a sensor observing an environment, the CFAR detection system being provided with an estimator adapted to determine an estimate of parameters related to noise affecting the sensor depending on parameters related to the environment, the method comprising the steps of:
estimation of parameters related to noises, in order to obtain a parameter vector,
computation of first detection thresholds so that, for all possible configurations of the parameter vector, the CFAR detection system operates at a predefined false alarm probability,
characterization of estimation errors of the estimator, and
correction of each first detection threshold in order to obtain second detection thresholds, the step of correcting taking into account the error parameters.

This patent application claims the benefit of document FR 22 13942 filed on Dec. 20, 2022 which is hereby incorporated by reference.

### FIELD OF THE INVENTION

The present invention relates to a method for determining detection thresholds for a constant false alarm rate detection system of a sensor. The present invention further relates to an observation method implementing the steps of the method for determining. The invention further relates to devices, namely a computer, a detection system and a vehicle.

### BACKGROUND OF THE INVENTION

In the field of detection, detection systems usually use signal processing methods. Such methods have the task of extracting, from a received signal, one or a plurality of portions corresponding to a relevant piece of information on the part of the environment which is the object of the detection.

If the case of radar is considered, the relevant piece of information corresponds to waves reflected by objects. The reflected waves or echoes can have a variable level depending on the nature and the dimensions of the objects considered.

For cases where the signal reflected by the object has a low amplitude, the processing of the radar signal seeks to extract the reflected signal from the thermal noise or the ambient clutter received by the radar receiver and which accompany the signal. The term “clutter” refers in the present case to the signal reflected by any element not the subject of detection. Clutter could be e.g. the signal reflected by elements of a terrain, constructions, bodies of water, vegetation or atmospheric phenomena such as clouds.

Such an extraction operation is e.g. implemented by a constant false alarm rate detection system. The acronym CFAR is often used for the term “constant false alarm rate”, so the system is often referred to as the CFAR detection system.

In general, a CFAR system works by analyzing any signal received by the receiver, by implementing a sequence of operations. For example, the CFAR detection system subtracts an average ambient signal level from the incident signal. The difference is then compared to a detection threshold. Any received signal the level of which exceeds the detection threshold is considered to be representative of the presence of an object at the relevant distance corresponding to the time of reception of the signal by the radar receiver.

Thereby, the correct operation of the CFAR detection system depends very much on the accuracy of the value of the detection threshold. As a result, in practice, it is not a detection threshold but a plurality of detection thresholds which are used, the thresholds depending on the environmental conditions in which the sensor operates.

However, CFAR detection systems exhibit degraded performance under certain circumstances, in particular when the environment includes areas of different nature generating significant variations in the clutter level.

### SUMMARY OF THE INVENTION

There is therefore a need for a method for determining detection thresholds for a constant false alarm rate detection system of a sensor.

To this end, the description describes a method for determining detection thresholds for a constant false alarm rate detection system of a sensor, the sensor being adapted to observe an environment, the constant false alarm rate detection system being provided with an estimator adapted to determine an estimate of parameters related to noises affecting the sensor depending on parameters related to the environment observed by the sensor, the method for determining being implemented by a calculator and comprising:
an step of estimating of parameters related to the noise affecting the sensor, in order to obtain a parameter vector,
a step of calculating first detection thresholds for the constant false alarm rate detection system, the first thresholds being computed so that, for all possible configurations of the parameter vector, the constant false alarm rate detection system operates at a predefined false alarm probability,
a step of characterizing the estimation errors of the estimator of the constant false alarm rate detection system, in order to obtain parameters relating to the estimation errors, and
a step of correcting the value of each first detection threshold in order to obtain second detection thresholds, the step of correcting taking into account the parameters relating to the estimation errors, the second detection thresholds being the thresholds determined for the constant false alarm rate detection system.

It should be understood herein that the steps of calculating the first thresholds and of characterizing the estimation errors in the estimation of the parameter vector are steps performed without using real data. Hence the steps can be carried out off-line, which is an important advantage of the method. The gain in reliability is obtained herein without resorting to a prolonged use of the detection system so that same comes across a representative set of use cases.

In this context, a noise affecting the sensor encompasses all the contributions to the detection of the sensor, which are not a target.

The main contributions to the noises thus comes from the thermal noise present in the electronic circuitry of the sensor, the clutter (radar echoes coming from the oceanic surface, the earth and/or any surface element not being a target) and atmospheric perturbations (for instance, clouds or rain).

According to particular embodiments, the method for determining detection thresholds has one or a plurality of the following features, taken individually or according to all technically possible combinations:
the step of correcting comprises, for each possible configuration of the parameter vector, the operations of:
   determination of the first detection threshold and of the first detection thresholds that the constant false alarm rate detection system is likely to use taking into account the estimation errors of the estimator, and
   modification of the values of the first detection thresholds that the constant false alarm rate detection system is likely to use, taking into account the estimation errors according to the different values of the first detection thresholds determined.
the step of correcting further includes an operation of calculating a best value among the first detection thresholds determined for ensuring that the constant false alarm rate detection system operates at a predefined false alarm probability, in order to obtain a best value obtained, and
during the modification operation, each of the values of the first detection thresholds that the constant false alarm rate detection system is likely to use given the estimation errors are replaced by the best value obtained.
the best value is the maximum of all the values determined during the determination operation.
the parameter vector includes a parameter related to the thermal noise of the sensor and a parameter related to the noise generated by the environment the sensor observes.
a parameter related to the noise generated by the environment the sensor observes characterizes the sea clutter.

The description further relates to a method of observing an environment by means of a sensor adapted to observe the environment, the sensor being part of a detection system comprising:
a sensor adapted to observe an environment,
a constant false alarm rate detection system of the sensor, the constant false alarm rate detection system being provided with an estimator adapted to determine an estimate of parameters related to noises affecting the sensor according to parameters related to the environment the sensor is observing, and
a calculator,
   the observation process including:
a step of implementing a method for determining detection thresholds of the constant false alarm rate detection system,
a step of receiving waves from the environment, and
an analysis step of the waves received by the constant false alarm rate detection system, in order to determine if the waves include only noise, the analysis being based on the determined thresholds.

The description further relates to a calculator adapted to determine detection thresholds of a constant false alarm rate detection system of a sensor, the sensor being adapted to observie an environment, the constant false alarm rate detection system being provided with an estimator adapted to determine an estimate of parameters related to noises affecting the sensor depending on parameters related to the environment observed by the sensor,

the calculator being adapted to:
estimate parameters related to noise affecting the sensor, in order to obtain a parameter vector,
compute first detection thresholds for the constant false alarm rate detection system, the first thresholds being computed so that, for all possible configurations of the parameter vector, the constant false alarm rate detection system operates at a predefined false alarm probability,
characterize estimation errors of the estimator of the constant false alarm rate detection system, in order to obtain parameters relating to estimation errors, and
correct the value of the first detection thresholds in order to obtain second detection thresholds, the step of correcting taking into account the parameters relating to estimation errors, the second detection thresholds being the thresholds determined for the constant false alarm rate detection system.

The description further relates to a detection system comprising:
a sensor being adapted to observe an environment,
a constant false alarm rate detection system of the sensor, the constant false alarm rate detection system being provided with an estimator adapted to determine an estimate of parameters related to noises affecting the sensor according to parameters related to the environment the sensor is observing, and
a calculator as described hereinabove.

The description further relates to a vehicle including a detection system such as described hereinabove.

In the present description, the expression “adapted to” means equally well “apt to”, “suitable for” or “configured for”.

### BRIEF DESCRIPTION OF THE DRAWINGS

The features and advantages of the invention will appear upon reading the following description, given only as an example, but not limited to, and making reference to the enclosed drawings, wherein:

FIG. 1 is a schematic representation of an example of vehicle,

FIG. 2 is a schematic representation flowchart corresponding to an example of implementation of a method for determining detection thresholds.

FIG. 3 is a schematic view of the result of the implementation obtained of a step of the method for determining shown in FIG. 2,

FIG. 4 is a schematic representation of the result of the implementation at a first stage of another step of the method for determining shown in FIG. 2,

FIG. 5 is a schematic representation of the result of the implementation at a second stage of the same stage as the step shown in FIG. 4, and

FIG. 6 is a schematic representation of the result of the implementation at a final stage of the same step as the step shown in FIG. 4.

### DETAILED DESCRIPTION OF THE PREFERRED EMBODIMENTS

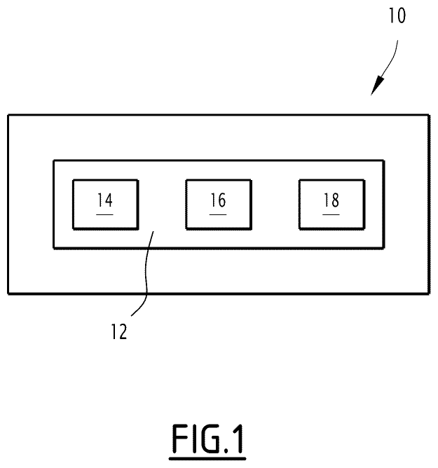

A vehicle 10 is schematically illustrated in FIG. 1.

The vehicle 10 is any type of vehicle and could be, more particularly, a land, air or sea vehicle.

The vehicle 10 includes a detection system 12 for detecting elements in an environment.

In this sense, the detection system 12 can be used as a monitoring system.

The detection system 12 includes a sensor 14, a constant false alarm rate detection device 16 and a calculator 18.

The sensor 14 is e. g. a radar.

Several types of radar can be envisaged, such as a tracking radar or a detection radar.

The radar can be used on the ground, at sea or in a mobile platform, such as an aircraft.

In a variant, the sensor 14 is a sonar.

According to another variant, the sensor 14 is an optronic sensor.

For example, the sensor 14 is an infra-red detector or a camera.

As indicated hereinabove, the CFAR detection device 16 is adapted to determine the signals exceeding a detection threshold according to the environment in which the sensor 14 works.

The calculator 18 is an on-board device adapted to control all the elements of the detection system 12.

According to the example described, the calculator 18 is adapted to implement a method for determining detection thresholds of the CFAR detection device 16.

For simplification, it is assumed herein that the calculator 18 implements all the steps of the method for determining.

However, in other embodiments, certain steps can be performed offline depending on the accessible data.

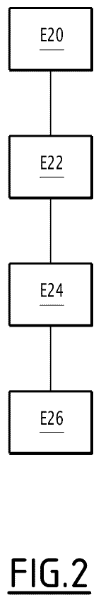

The operation of the calculator 18 will now be described with reference to FIG. 2 which shows a flowchart of an example of implementation such a method for determining.

The method for determining seeks to obtain detection thresholds for the CFAR detection device 16, which would improve the performance of the detection device 16.

The method for determining comprises, according to the example of FIG. 2, four steps which are an step of estimating E20, a computation step E22, a characterization step E24 and a step of correcting E26.

During the step of estimating E20, the calculator 18 receives a set of observations of the environment, by means of the sensor 14.

From such observations, the calculator 18 estimates a parameter vector C.

The parameters of the parameter vector C are used for characterizing the phenomena leading to spurious signals at the sensor 14.

Thereby, the parameters of the parameter vector C are parameters characterizing the law of probability of occurrence of such phenomena.

The parameters can generally be estimated easily, in particular using the altitude, the geometry of observation or the thermal noise temperature.

The parameter vector C is thus a set of parameters related to the noises affecting the sensor 14.

As a particular example, in the case of a sensor working in an environment including both air and water, the spurious phenomena or nuisances are of two types, a first phenomenon linked to sea echoes and a second phenomenon linked to the thermal noise of the detection system 12.

The first phenomenon has a power often modeled by a K(uc, v) law, with uc the mean power and v the form factor of the law, describing the impulsive character of sea clutter.

In this expression, the form factor v (impulsive character) is the most determining factor.

According to the example described, the behavior of the second phenomenon is given by a parameter un which corresponds to the average power. The thermal noise is then usually modeled by a power law such as

$$Exp ( \frac{1}{{μ}_{n}} ) .$$

Alternatively, the second phenomenon can be characterized by a parameter CNR, the acronym CNR referring to the corresponding name of “clutter-to-noise ratio”. The parameter CNR is given by the power of the sea clutter compared to the thermal noise.

Thereby, it can be envisaged in the example described that the parameter vector C includes two parameters, namely the impulsive character v of the sea clutter and the parameter CNR (clutter-to-noise ratio).

Through such example, it appears that the parameter vector C preferentially includes a parameter related to the thermal noise of the sensor 14 and a parameter related to the noise generated by the environment the sensor 14 observes.

Thereby, the calculator 18 has the parameter vector C at the end of the implementation of the step of estimating E20.

The parameter vector C is adapted to take a set of values corresponding to all possible values for each parameter. Each set of possible values is a possible configuration of the parameter vector C.

The goal of the method described is to determine the thresholds that the CFAR detection device 16 will use in order to obtain the best possible performance for the detection system 12.

During the calculation step E22, the calculator 18 computes first detection thresholds by taking into account the parameter vector and a predefined false alarm rate.

Hereinafter in the description, the predefined false alarm rate is called Pfaₑₜₚₒᵢₙₜ.

Such a computation can be carried out by any means known to a person skilled in the art.

As a particular example for the described case of a sensor working in an environment including both air and water, the calculator 18 can implement the following operations.

The calculator 18 usually determines a test statistic x maximizing the detection probability for a probability of false alarm Pfaₛₑₜₚₒᵢₙₜ=1−α.

For this purpose, the calculator 18 can advantageously use Swerling models, the statistical distributions of the different sources of noise (clutter and thermal noise for the example described herein), and the Neyman-Pearson Lemma.

Once the expression of the optimal test statistic is known, the calculator 18 evaluates the statistical distribution fₙ(x, C) of the test statistic x under the assumption that same originates from the noise signal.

The calculator 18 obtains the distribution fₙ analytically or by implementing a Monte-Carlo method.

The calculator 18 then determines a first detection threshold S1_{pfa}_{ₛₑₜₚₒᵢₙₜ} by inverting the following integral:

$${Pfa}_{consigne} = {\int }_{{B}_{inf}}^{S {1}_{{Pfa}_{setpoint}}} {f}_{nuisance} ( x , C ) dx$$

With B_{inf} the lower boundary of the support of x (if x ∈ R⁺, B_{inf}=0).

For a simple law, the calculator 18 can perform such an inversion analytically.

But in the complex case described, the calculator 18 performs the inversion numerically in a set of points (parameterizations of C), by dichotomy.

According to another example, the calculator 18 uses a least squares method combined with a gradient descent.

By proceeding in the above way for all possible values of the parameter vector, a set of first detection thresholds is obtained for each value of the parameters of the parameter vector C.

In the example described, the above thus corresponds to a table giving the correct detection threshold for a value of the impulsive character v of the sea clutter and the parameter CNR (clutter-to-noise ratio).

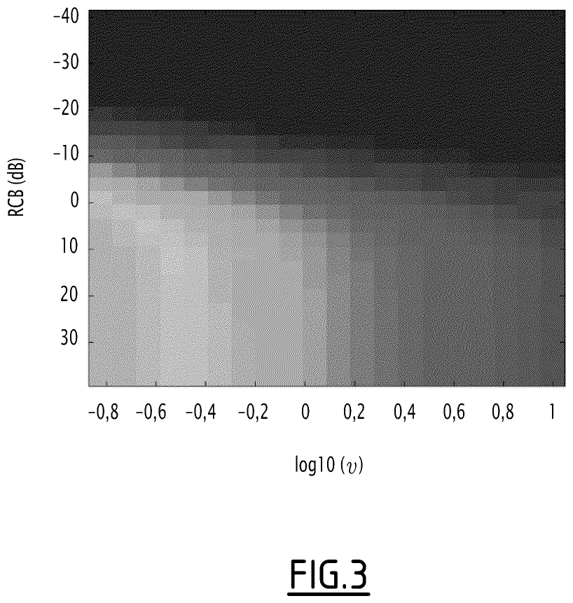

Such a table can thus be represented graphically as a map as can be seen in the representation of FIG. 3.

In said figure, the value of the threshold is represented in the form of gray levels according to the values of the impulsive character v of the sea clutter (in the form of log₁₀(v) herein) and of the parameter CNR (clutter-to-noise ratio, expressed in dB). Each gray level gives the threshold value for a box corresponding to a set of values of the two parameters.

Thereby, at the end of the calculation step E22, the calculator 18 has computed first detection thresholds for the CFAR detection device 16 so that, for all possible configurations of the parameter vector, and in the absence of estimation errors on the parameter vector (i.e. the calculator 18 knows perfectly the parameterization of the statistical laws of clutter and thermal noise nuisance), the CFAR detection device 16 operates at a predefined false alarm probability.

During the characterization step E24, the calculator 18 seeks to characterize the performance of the estimator denoted by Ĉ of the parameter vector C used during the step E20.

The estimator Ĉ is an estimator with which the CFAR detection device 16 is provided.

The estimator Ĉ is adapted to determine an estimate of the parameters related to the noises affecting the sensor 14 depending on parameters related to the environment the sensor 14 observes.

Example of parameters related to the environment include the altitude of the vehicle 10, the type of environment (e.g. land or water e.g.) or meteorological information (presence of clouds, rain or other).

The estimator Ĉ thus corresponds to a function of the CFAR detection device 16, which can take any form known to a person skilled in the art.

In the present case, it is a question of characterizing the estimation errors made by the estimator Ĉ.

According to one example, performance is expressed as parameters of a distribution law.

Such a step can be implemented by an analytical resolution when the distributions of the phenomena generating nuisances are known.

Alternatively, it is possible to use Monte Carlo methods or numerical integration methods. According to another example, performance is expressed in the form of moments of a distribution law.

By denoting by C₀ the true parameter vector to be estimated, performing the characterization step can thus consist in theoretically quantifying the first two moments of the estimator Ĉ for each parameterization C₀ (possible parameter values) of the parameter vector C.

The first two moments of the estimator Ĉ are defined as follows:

$${Bias}_{\hat{C}} ( {C}_{0} ) = E [ \hat{C} - {C}_{0} ]$$

$${Var}_{\hat{C}} ( {C}_{0} ) = E [ {( \hat{C} - {C}_{0} )}^{2} ]$$

With E [.] the mathematical expectation operator.

The first moment (Bias_{Ĉ}(C₀)) corresponds to the mean estimation error while the second moment (Var_{Ĉ}(C₀)) corresponds to the variance of the estimation error.

It would also be possible to consider higher order moments in the implementation of the characterization step E24.

With reference to the above-mentioned example relating to a sensor working in an environment including both air and water, it is observed that the CFAR detection systems 16 generally have the fault of underestimating the value of the impulsive character v of the sea clutter.

The values characterizing the performance are used for quantifying such a fault of estimation.

Hence, at the end of the characterization step E22, the calculator 18 has also values characterizing the estimation errors of the CFAR detection device 16.

As a remark, it will be understood that the first detection thresholds take into account only the parameters of the parameter vector C and do not take into account the values characterizing the estimation performance of the CFAR detection device 16. Hence, the first detection thresholds are not perfectly reliable.

Thereby, the calculation steps E22 and the characterization steps E24 can be carried out jointly after the implementation of the step of estimating E20.

Moreover, as indicated hereinabove, such steps could also be carried out offline.

During the step of correcting E24, the calculator 18 seeks to correct the values of the first detection thresholds by taking into account the values characterizing the estimation performance of the CFAR detection device 16.

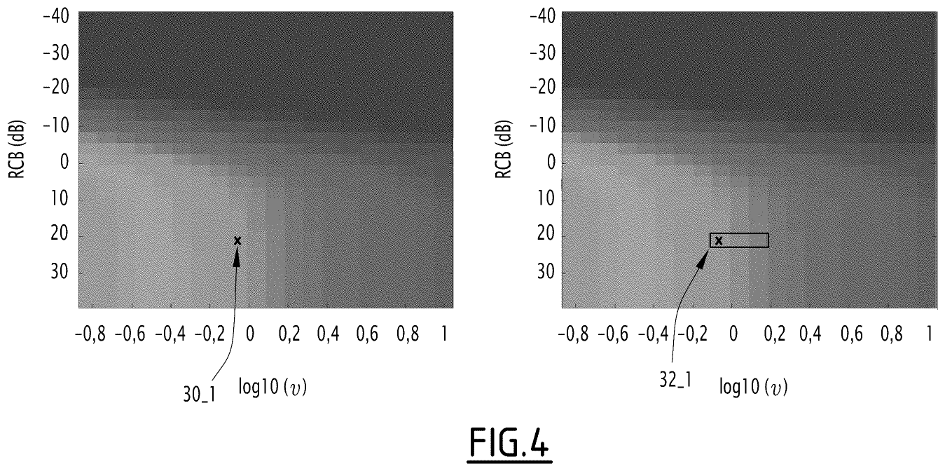

In order to explain in detail how the calculator 18 performs such a correction, an example is now described with reference to FIGS. 4 to 6, still for the case of a hybrid air/water detection.

The case shown in FIG. 4 corresponds to the case of a possible configuration of the parameter vector C, called C₁ corresponding to C₁=[CNRv₁]^{T}.

For the configuration C₁, a value has been determined ensuring compliance with the predefined false alarm rate Pfa. On FIG. 4, said value is indicated by the reference sign 30.

It is assumed for such configuration, the error that the estimator Ĉ is likely to make on the estimation of the parameter CNR is less than the resolution of the graph (the size of a box in FIG. 7 is larger than the error made by the estimator Ĉ on the parameter CNR) whereas for the component relating to the impulsive character, the estimator Ĉ is likely to make an error of up to 4 cells. The values are derived from the calculation carried out during the characterization step E24.

All of the values of first detection thresholds the CFAR detection device 16 is likely to use taking into account the estimation errors corresponds in such case to a rectangle 32 represented in FIG. 4. Said values are the values to be modified.

According to the example described, the calculator 18 replaces the values to be modified by the maximum of the first thresholds determined. In the present case, the above leads to increasing the values to be modified.

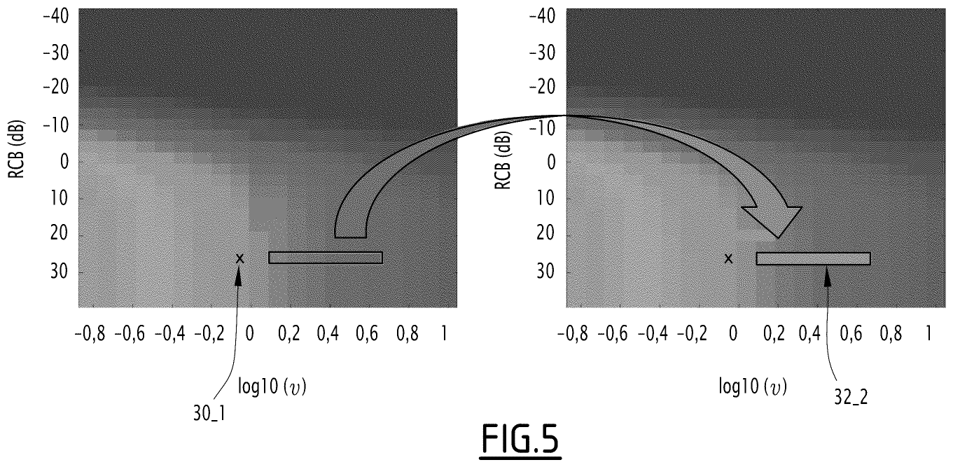

FIG. 5 illustrates the same mechanism for a second configuration C₂. There again, the above leads to raising the values of the first thresholds contained in a rectangle 32.

Such correspondence between the rectangular shape 32 and the estimation errors determined can be explained as follows.

The precise dimensioning of the zone presupposes knowing the a priori probability of appearance of each configuration of the vector of parameters C, so as to dimension X=[X_{INF}, X_{SUP}], the zone actually seen by the CFAR detection device 16 in the map which can be qualified so that (one-dimensional case):

$$Pfa = {\int }_{{i}_{INF}}^{{i}_{SUP}} ( {\int }_{{X}_{INF}}^{{X}_{SUP}} ( {\int }_{{T}_{marge} ( PFa , {C}_{j} )}^{{Y}_{SUP}} {f}_{Y} ( y \vert {C}_{i} ) dy ) {f}_{\hat{C}} ( {C}_{j} \vert {C}_{i} ) {dC}_{j} ) {f}_{C} ( {C}_{i} ) {dC}_{i}$$

With:
f_{Y}(y|Cᵢ) the distribution of test statistics Y knowing the configuration Cᵢ, i being an index referring to all the configurations Cᵢ
f_{Ĉ}(Cⱼ|Cᵢ) the distribution of the estimates given by the estimator Ĉ of the parameter vector C for the configuration Cᵢ,
f_{C}(Cᵢ) the a priori distribution of the configurations Cᵢ of the parameter vector C,
[i_{INF}, i_{SUP}] The support of the parameter vector C (configurations likely to be encountered in a real environment)
Y_{SUP} the upper limit of the support of the test statistic Y

Thus formulated, the problem to be solved (dimensioning of the zone X) also requires having the table of the margined threshold Tmarge, which is margined using the range X.

As a first approximation, the a priori distribution of the configurations Cᵢ can be considered to be uniform, and the maintenance of the Pfa can be approximately obtained in a simplified manner.

For the example described hereinabove, for a configuration Cᵢ of C, the characterization of the estimator Ĉ gives:
A bias vector μ_{C}_{ᵢ}
A covariance matrix of the error Σ_{C}_{ᵢ}

In application of the maximum entropy principle, the distribution of estimation errors of Ĉ for the configuration Cᵢ thereby corresponds to the following formula:

$$\hat{C} \sim 𝒩 ( {μ}_{{C}_{i}} , {Σ}_{{C}_{i}} )$$

With N the normal law.

Thereby, the following criterion has to be satisfied:

$$ℙ ( \sqrt{{( \hat{C} - {μ}_{{C}_{i}} )}^{T} {\sum }_{{C}_{i}}^{- 1} ( \hat{C} - {μ}_{{C}_{i}} )} > \frac{{X}_{SUP} - {X}_{INF}}{2} ) = c . Pfa$$

With c<1 so that the area is “sufficiently large” with respect to the predefined false alarm rate Pfa. The above corresponds to the fact that the probability that the estimator Ĉ will fall outside of the zone is negligible compared to the predefined false alarm rate Pfa.

In the case of a one-dimensional parameter vector C, one thus obtains:

$$\frac{{X}_{SUP} - {X}_{INF}}{2} = \sqrt{2} . {erf}^{- 1} ( 1 - c . Pfa )$$

And in general, the criterion defines the zone to be raised as an ellipsoid of equation:

$$\sqrt{{( {C}_{r} - {μ}_{{C}_{i}} )}^{T} {\sum }_{{C}_{i}}^{- 1} ( {C}_{r} - {μ}_{{C}_{i}} )} \leq \frac{{X}_{SUP} - {X}_{INF}}{2}$$

With Cᵣ coordinates of the points to be raised.

After discretization, the ellipsoid corresponds to the rectangle visible in FIGS. 4 and 5.

All the operations which have just been described are repeated for each configuration.

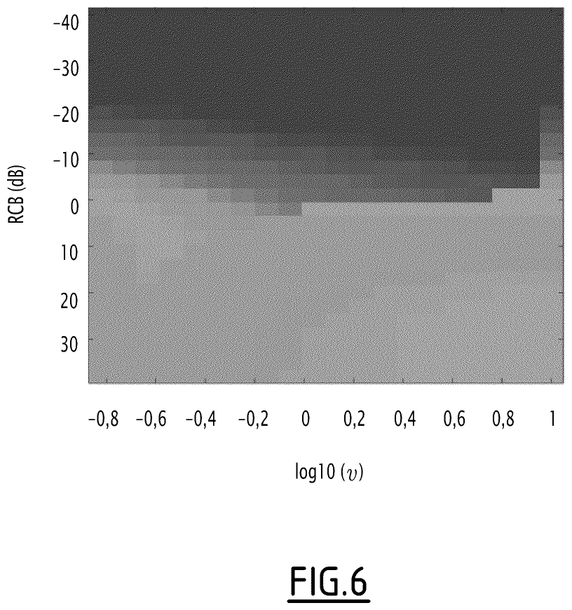

Thereby, the map shown in FIG. 6 is obtained, which brings together the values of modified first thresholds, which corresponds to second detection threshold values.

By comparison with the map shown in FIG. 3, the second detection threshold values are increased with respect to the first modified detection thresholds.

The second detection threshold values lead to a better compliance with the predefined false alarm probability.

Such better compliance appears in the context of a method of observation of an environment which then includes a step of receiving waves coming from the environment, and a step of analyzing the waves received by the CFAR detection device 16 in order to determine whether the waves include only noise, the analysis being based on the second detection thresholds.

The use of the second detection thresholds thus raised certainly degrades the probability of detection but leads to a better compliance with the desired probability of false alarm.

The method which has just been described is thus a more reliable method for determining detection thresholds for a constant false alarm rate detection system of a sensor.

Other embodiments of the method can be considered while leading to obtaining such an increase in reliability.

More particularly, during the step of correcting, it is possible to use an operation other than the maximum, such as an operation consisting simply in taking the value determined by the computation step.

It could also be contemplated to calculate an additional margin to be added taking into account estimation errors.

1. A method for determining detection thresholds of a constant false alarm rate detection device of a sensor,
the sensor being adapted to observe an environment, the constant false alarm rate detection device being provided with an estimator adapted to determine an estimate of parameters related to noises affecting the sensor depending on parameters related to the environment observed by the sensor,
the method for determining being implemented by a calculator and comprising:
an step of estimating parameters related to the noises affecting the sensor, in order to obtain a parameter vector,
a step of calculating first detection thresholds for the constant false alarm rate detection device, the first thresholds being computed so that, for all possible configurations of the parameter vector, the constant false alarm rate detection device operates at a predefined false alarm probability,
a step of characterizing the estimation errors of the estimator of the constant false alarm rate detection device, in order to obtain parameters relating to the estimation errors, and
a step of correcting the value of each first detection threshold in order to obtain second detection thresholds, the step of correcting taking into account the parameters relating to the estimation errors, the second detection thresholds being the thresholds determined for the constant false alarm rate detection device.

2. The method for determining according to claim 1, wherein, the step of correcting includes, for each possible configuration of the parameter vector, the operations of:
determination of the first detection thresholds that the constant false alarm rate detection device is suitable for being used taking into account the estimation errors of the estimator, and
modification of the values of the first detection thresholds that the constant false alarm rate detection device is suitable for being used, taking into account the estimation errors according to the different values of the first detection thresholds determined.

3. The method for determining according to claim 2, wherein, the correcting step further includes an operation of calculating a best value among the first detection thresholds determined for ensuring that the constant false alarm rate detection device operates at a predefined false alarm probability, in order to obtain a best value obtained, and during the modification operation, each of the values of the first detection thresholds that the constant false alarm rate detection device is suitable for being used taking into account the estimation errors are replaced by the best value obtained.

4. The method for determining according to claim 3, wherein the best value is the maximum of all the values determined during the determination operation.

5. The method for determining according to any claim 1, wherein the parameter vector includes a parameter related to the thermal noise of the sensor and a parameter related to the noise generated by the environment the sensor observes.

6. The method for determining according to claim 1, wherein a parameter related to noise generated by the environment the sensor observes, characterizes the sea clutter.

7. A method of observing an environment by a sensor adapted to observe the environment, the sensor being part of a detection system comprising:
a sensor adapted to observe an environment,
a constant false alarm rate detection device of the sensor, the constant false alarm rate detection device being provided with an estimator adapted to determine an estimate of parameters related to noises affecting the sensor according to parameters related to the environment the sensor is observing, and
a calculator,
the method for observing including:
a step of implementing a method for determining detection thresholds of the constant false alarm rate detection device,
a step of receiving waves from the environment, and
a step of analyzing the waves received by the constant false alarm rate detection device, in order to determine if the waves contain only noise, the analysis being based on the determined thresholds.

8. A calculator adapted to determine detection thresholds of a constant false alarm rate detection device of a sensor,
the sensor being adapted to observe an environment, the constant false alarm rate detection device being provided with an estimator adapted to determine an estimate of parameters related to noises affecting the sensor depending on parameters related to the environment observed by the sensor,
the calculator being adapted to:
estimatie parameters related to the noise affecting the sensor, in order to obtain a parameter vector,
calculate first detection thresholds for the constant false alarm rate detection device, the first thresholds being computed so that, for all possible configurations of the parameter vector, the constant false alarm rate detection device operates at a predefined false alarm probability,
characterize estimation errors of the estimator of the constant false alarm rate detection device, in order to obtain parameters relating to estimation errors, and
correct the value of the first detection thresholds in order to obtain second detection thresholds, the step of correcting taking into account the parameters relating to the estimation errors, the second detection thresholds being the thresholds determined for the constant false alarm rate detection device.

9. A detection system comprising:
a sensor adapted to observe an environment,
a constant false alarm rate detection device of the sensor, the constant false alarm rate detection device being provided with an estimator adapted to determine an estimate of parameters related to noises affecting the sensor depending on parameters related to the environment the sensor is observing, and
a calculator (18) according to claim 8.

10. A vehicle including a detection system according to claim 9.
